(19) United States
(12) Patent Application Publication
(10) Pub. No.: US 2013/0327662 A1
(43) Pub. Date: Dec. 12, 2013

(54) MUSICAL INSTRUMENT CARRYING CASE AND STAND

(71) Applicant: Joseph Peter Loban, Chicago, IL (US)

(72) Inventor: Joseph Peter Loban, Chicago, IL (US)

(21) Appl. No.: 13/735,860

(22) Filed: Jan. 7, 2013

Related U.S. Application Data
(63) Continuation-in-part of application No. 12/709,668, filed on Feb. 22, 2010, now Pat. No. 8,348,055.

(51) Int. Cl. G10G 7/00; G10G 5/00

(52) U.S. Cl. CPC G10G 7/005; G10G 5/00
USPC 206/314

(57) ABSTRACT

A musical instrument carrying case and stand that includes a case having an internal cavity configured to hold a musical instrument, such as a guitar. The case comprises a non-rigid material. One or more slits allowing access to the internal cavity are provided in the case, and the one or more slits are positioned to define at least one flap. The musical instrument carrying case and stand further includes a support element that is pivotally attached to a back side of the case. The support element pivots between a first position in which the support element is substantially parallel with the back of the case and a second position in which the support element is able to support the case without the musical instrument being disposed therein.

### BACKGROUND OF THE INVENTION

The present invention relates broadly to a carrying case for a musical instrument. More particularly, the invention relates to a musical instrument carrying case that also functions as a stand, where the carrying case is comprised of a non-rigid material.

Professional and amateur players of guitar, banjo, violin, or other stringed instruments are extremely protective of their instruments, which are typically delicate and expensive devices. Damage to a stringed instrument often affects both the looks and the musical quality of the instrument (including the sound of the instrument and monetary value). Thus, professional and amateur players typically must take great care of their instruments, especially during transport or when the player is not using the instrument.

Typically, a stringed instrument is transported in a rigid or hard shell case for protection. These rigid or hard shell cases have handles for the player to carry the instrument much like a suitcase, which is typically not a comfortable means for manually carrying the instrument.

Non-rigid or soft shell bags or cases are commercially available and often equipped with straps for the player to comfortably carry the instrument on his or her back. However, non-rigid or soft shell bags or cases typically do not offer the protection that a rigid or hard shell case provides such that a player has to take extra care in setting down the non-rigid or soft shell bag or case containing the instrument on the floor, against a wall, or against a chair or other furniture.

When setting up for a performance, the player often uses a separate stand for the instrument that prevents the instrument from falling over and being damaged when not in use. Having an instrument stand in addition to a carrying case is an additional purchase and travel cost for the player. Moreover, having a separate stand and carrying case is an inconvenience for the player, who must transport both devices and, for each performance, expend time unpacking and setting up the stand, unpacking the instrument from the case, securing the instrument on the stand, and performing the reverse tasks when the performance is concluded.

Combination carrying cases and stands for musical instruments exist in the prior art as disclosed in, for example, U.S. Pat. No. 5,833,051, U.S. Pat. No. 6,462,260, U.S. Pat. No. 6,951,280 and U.S. Pat. No. 6,959,810. However, existing combination carrying cases and stands are typically formed with a rigid frame or hard shell case that is not comfortable for a player to manually carry and is more expensive than non-rigid or soft shell carrying cases or bags.

Therefore, a need exists for a combination carrying case and stand for a musical instrument that overcomes the problems noted above and others previously experienced with cases having a rigid frame or hard shell case.

### SUMMARY OF THE INVENTION

In accordance with embodiments of the present invention, a musical instrument carrying case and stand is provided that overcomes the problems noted herein with conventional carrying cases and stands. As a general matter, the musical instrument carrying case and stand comprises a case having an internal cavity configured to hold a musical instrument, such as a guitar. The case comprises a non-rigid material. One or more slits allowing access to the internal cavity are provided in the case, and the one or more slits are positioned to define at least one flap. The musical instrument carrying case and stand further comprises a support element that has a first end and a second end. The first end is pivotally attached to a back side of the case. The support element pivots between a first position in which the support element is substantially parallel with the back side of the case and a second position in which the second end of the support element is set away from the case. When the support element is in the second position, the support element is able to support the case without the musical instrument being disposed therein.

In accordance with one embodiment of the musical instrument carrying case and stand, the musical instrument carrying case and stand includes a case that has a bottom side, a top side, a back side, and a front side that collectively define a cavity within the case to hold a musical instrument. The case is formed from a non-rigid material. The front of the case has a vertical slit and a horizontal slit that collectively define a flap on the upper portion of the front of the case and a front panel on the lower portion. The horizontal slit is positioned to define a pocket within the case in the lower portion of the internal cavity. The musical instrument carrying case and stand further includes a support element is pivotally attached at a first end to the back of the case by which the support element pivots between a first position and a second position. In the first position, the support element is substantially parallel to the back of the case. In the second position, the second end of support element is at a second predetermined distance such that the support element supports the lower portion of the internal cavity of the case when the musical instrument is removed.

In one implementation, the second predetermined distance is set such that when the support element is in the second position, the support element maintains the back side of the case taut below the point where the first end of the support element is pivotally attached to the back side of the case and the pocket remains in an open position when the musical instrument is removed.

In another implementation, the vertical slit effectively intersects the horizontal slit to define the first flap and a second flap on the front of the case. In a further implementation, a first part and second part of a first fastening element may be attached to the first flap and the second flap, respectively. The first part may be adapted to selectively engage the second part to vertically fasten the first flap to the second flap. A third part of a second fastening element may be attached to the first flap; a fourth part of the second fastening element may be attached to the second flap; and a fifth part of the second fastening element may be attached to the front panel. The third and fourth parts may be adapted to selectively engage the fifth part to horizontally fasten the first and second flaps to the front panel. The first fastening element may be a first zipper with the first part and second part of the first fastening element being complementary teeth of the first zipper. The second fastening element may also be a second and a third zipper with the third part and a portion of the fifth part of the second fastening element being complementary teeth of the second zipper and with the fourth part and a remainder of the fifth part of the second fastening element being complementary teeth of the third zipper.

A further implementation may have a first member and a second member attached to the back of the case so that the first end of the support element is disposed between the first and second members. The support element, the second member, and the third member may each have a respective thickness and be planar. In this implementation, when the support element is in the first position, the support element, the first member, and the second member are substantially co-planar. The first and second members may also be positioned such that, when the second end of the support element is wider than the first end of the support element, the first and second members guide and horizontally retain the support element between the first and second members when the support element is in the first position.

A strap may also be attached between the back side of the case and the support element. When the support element is in the first position the strap causes the support element, the first member, and the second member to be co-planar. A third fastening element may also be attached to the back side of the case and the support element to selectively attach the support element to the back side of the case and cooperatively retain the support element in a co-planar position with the first and second members.

In another embodiment of the musical instrument carrying case and stand, the musical instrument carrying case and stand includes a case that has a bottom side, a top side, a back side, and a front side that collectively define an internal cavity configured to accommodate and enclose a musical instrument. The case is formed of a non-rigid material. A first member and a second member are each affixed to the back side of the case. The musical instrument carrying case and stand further includes a support element, having a first end and a second end, is pivotally attached to the first and second members at a first predetermined distance from the bottom of the case such that the support element pivots between a first position, in which the support element is substantially parallel with the back of the case, and a second position, in which the second end of the support element is at least a second predetermined distance away from the bottom of the case such that support element sufficiently supports the case when the musical instrument is removed from the case.

In one implementation, the front side of the case has a vertical slit and a horizontal slit that collectively define a first flap and a front panel, and the horizontal slit is disposed at the first predetermined distance from the bottom of the case so as to define a pocket within the case. The vertical slit may effectively intersect the horizontal slit to define a first flap and a second flap. Additionally, there may be a first fastening element having a first part and a second part. The first part may be attached to the first flap and the second part may be attached to the second flap. The first part may be adapted to selectively engage the second part to vertically fasten the first flap to the second flap. There may also be a second fastening element having a third part attached to the first flap, a fourth part attached to the second flap, and a fifth part attached to the front panel. The third part may be adapted to selectively engage a portion of the fifth part to horizontally fasten the first flap to the front panel and the fourth part may be adapted to selectively engage a remainder of the fifth part to horizontally fasten the second flap to the front panel.

In yet another embodiment of the musical instrument carrying case and stand, the musical instrument carrying case and stand includes a case that has a front side, a back side, a top side, and a bottom side that collectively define an internal cavity configured to accommodate a musical instrument. The front side and the back side are adjoined by a first side portion and a second side portion that extend between the top side and the bottom side. The case is formed from a non-rigid material. The case also has a slit that extends (a) relatively vertically down the first side portion of the case to a first position, (b) relatively vertically down the second side portion of the case to a second position, and (c) across the top side of the case, where the top side is between the first and second side portions. The slit defines at least one flap, and the first position and the second position are each provided at a respective predetermined distance from the bottom of the case so as to define a pocket within the case corresponding to a lower portion of the internal cavity. The musical instrument carrying case and stand further includes a support element having a first end and a second end. The first end is pivotally attached to the back side, and the support element pivots between one position in which the support element is substantially parallel with the back side of the case and another position in which the second end of the support element is at least a second predetermined distance away from the bottom of the case such that the support element supports the lower portion of the internal cavity of the case when the instrument is removed from the pocket.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 is a front view of one embodiment of a musical instrument carrying case and stand consistent with the present invention;

FIG. 2 is a front view of the musical instrument carrying case and stand of FIG. 1 showing vertical and horizontal slits and corresponding fastening elements of the carrying case for enclosing the musical instrument within the case;

FIG. 3 is a perspective rear view of the musical instrument carrying case and stand of FIG. 1 showing the stand in a case supporting position in accordance with the present invention;

FIG. 4A is an enlarged perspective view of the bottom portion of the musical instrument carrying case and stand of FIG. 1, showing the stand in the case supporting position with other components of the case removed to avoid obscuring the stand;

FIG. 4B is a perspective view of a bottom portion of a second embodiment of a musical instrument carrying case consistent with the present invention;

FIG. 5 is a front view of the musical instrument carrying case and stand of FIG. 1, showing a pocket in the case for holding the instrument upright in cooperation with the stand in accordance with the present invention;

FIG. 6 is a side view of the musical instrument carrying case and stand of FIG. 1, showing the pocket in the case in an open position and the stand supporting the case in accordance with the present invention such that the pocket remains in the open position;

FIG. 7 is a rear view of the musical instrument carrying case and stand of FIG. 1, showing the stand in a carrying position in accordance with the present invention; and

FIG. 8 is a side view of the musical instrument carrying case and stand of FIG. 1 as carried by a user in accordance with the present invention.

FIG. 9 is a side view of one example of a musical instrument carrying case and stand in accordance with another embodiment of the present invention.

FIG. 10 is a side view of the musical instrument carrying case and stand in accordance with the embodiment of FIG. 9, showing front and back flaps.

FIG. 11 is a rear view of the musical instrument carrying case and stand in accordance with the embodiment of FIG. 9.

FIG. 12 is a front view of the musical instrument carrying case and stand in accordance with the embodiment of FIG. 9, showing a pocket in an internal cavity in an open position and including a front pocket with the front flap being tucked therein.

### DETAILED DESCRIPTION OF THE INVENTION

Reference will now be made in detail to implementations in accordance with products consistent with the present invention as illustrated in the accompanying drawings.

Musical instrument players take great pride and care in maintaining their instruments during transport and display. A hard-shell case, while protective, can be cumbersome and uncomfortable to carry. A combination soft-shelled case and stand for musical instruments provides a comfortable alternative for transporting a musical instrument and eliminates the need for carrying a separate stand. A soft-shelled carrying case and stand also provides a less expensive alternative to the hard-shelled cases and stands currently available. Other advantages of the present invention are disclosed or will become apparent in the description to follow.

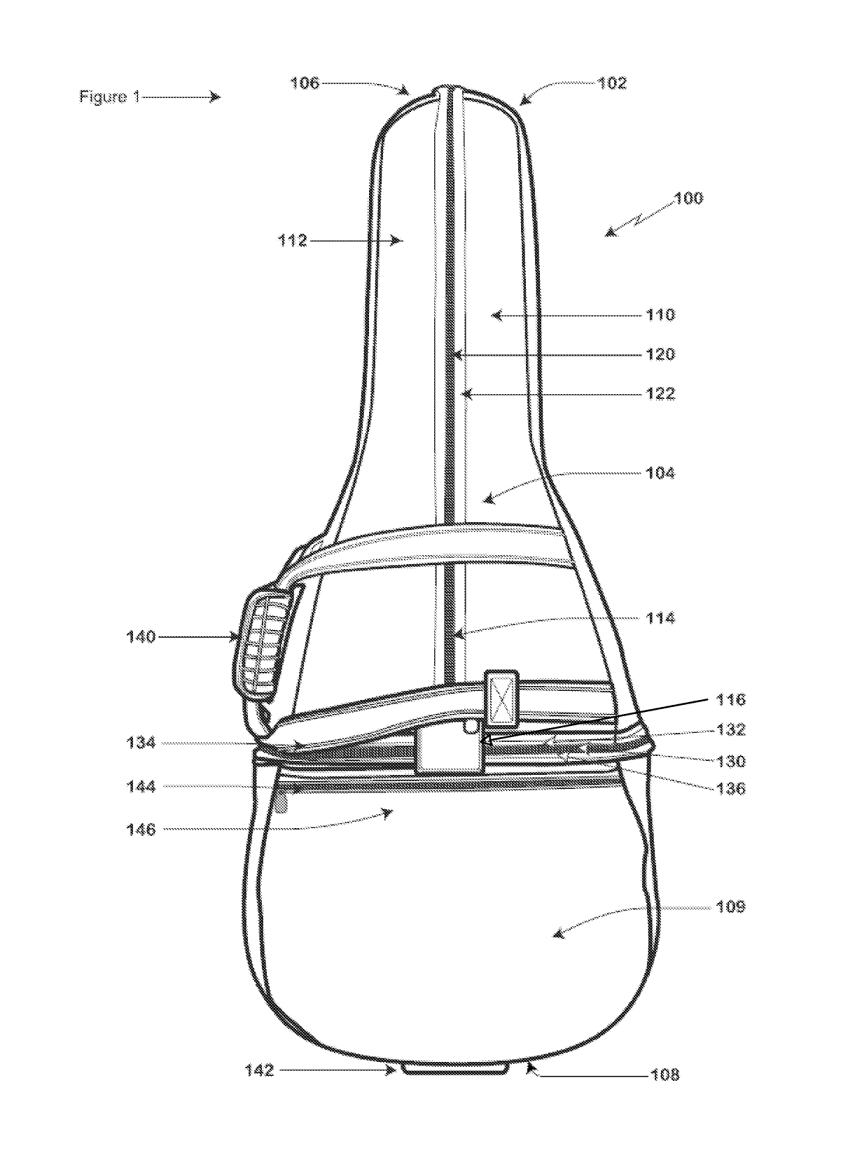

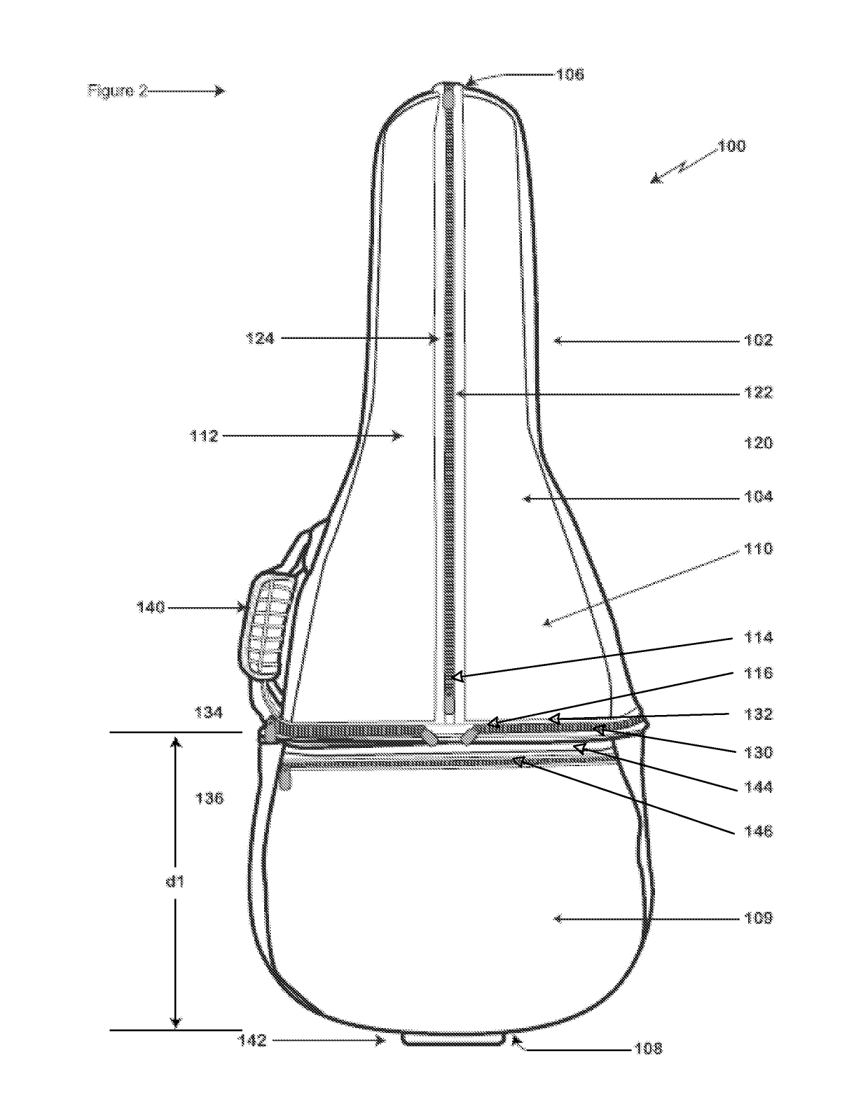

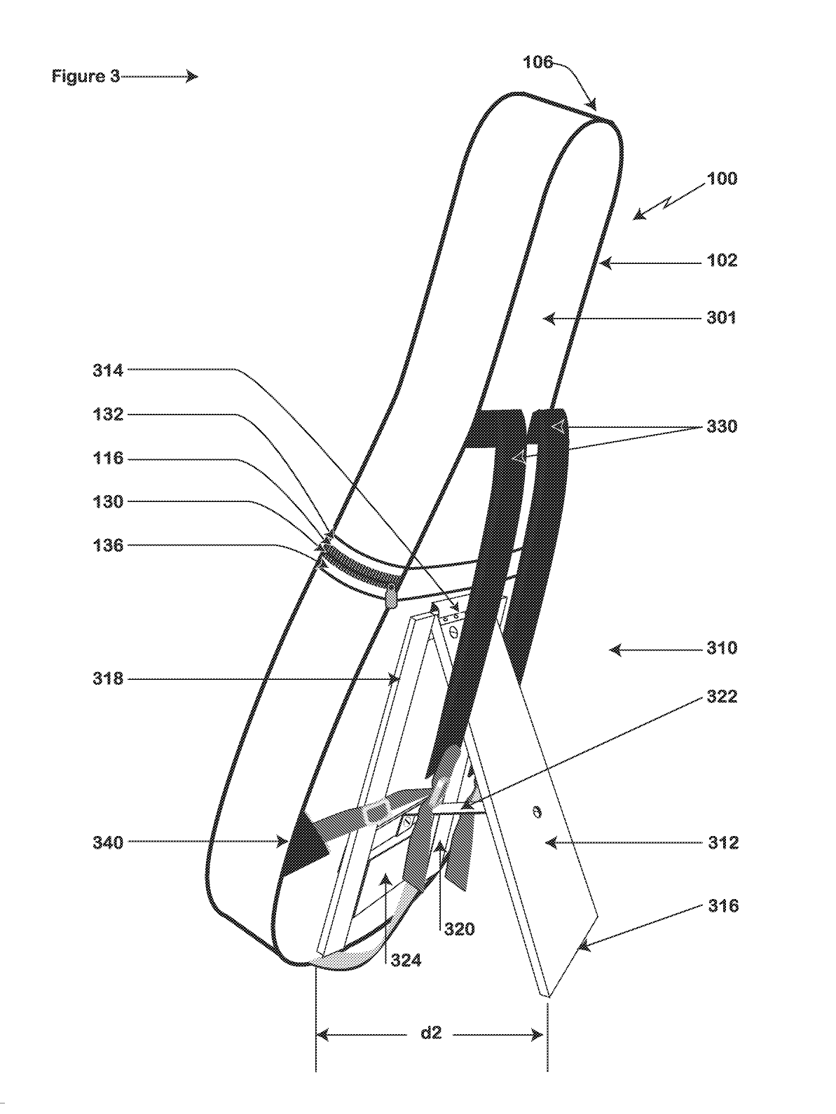

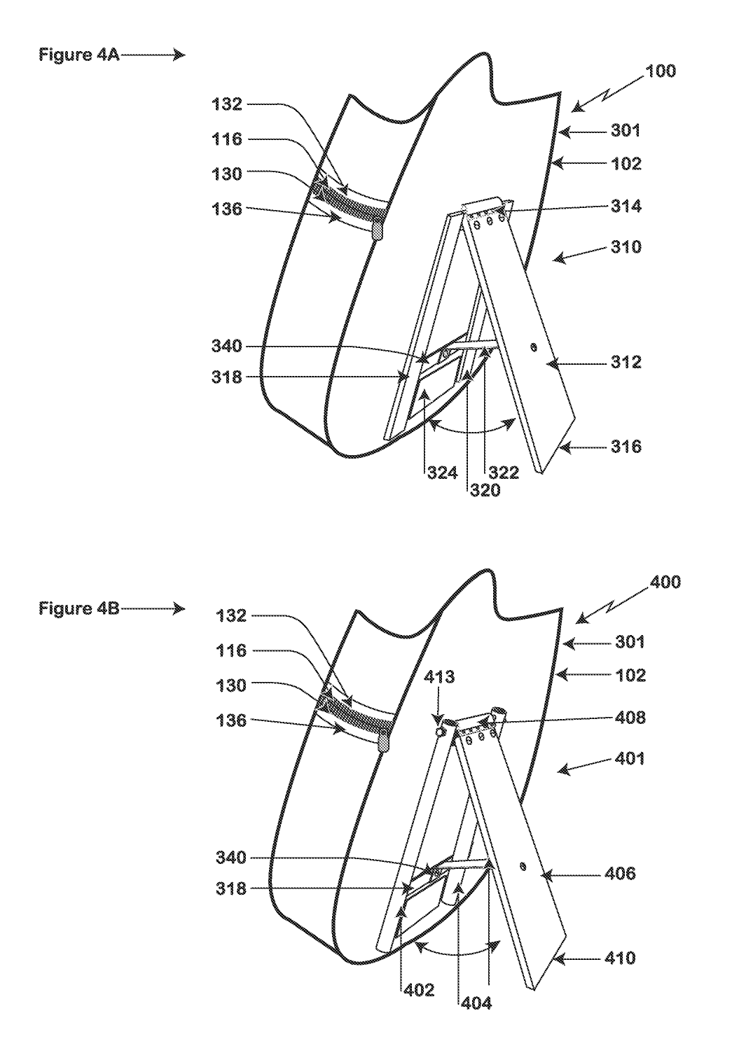

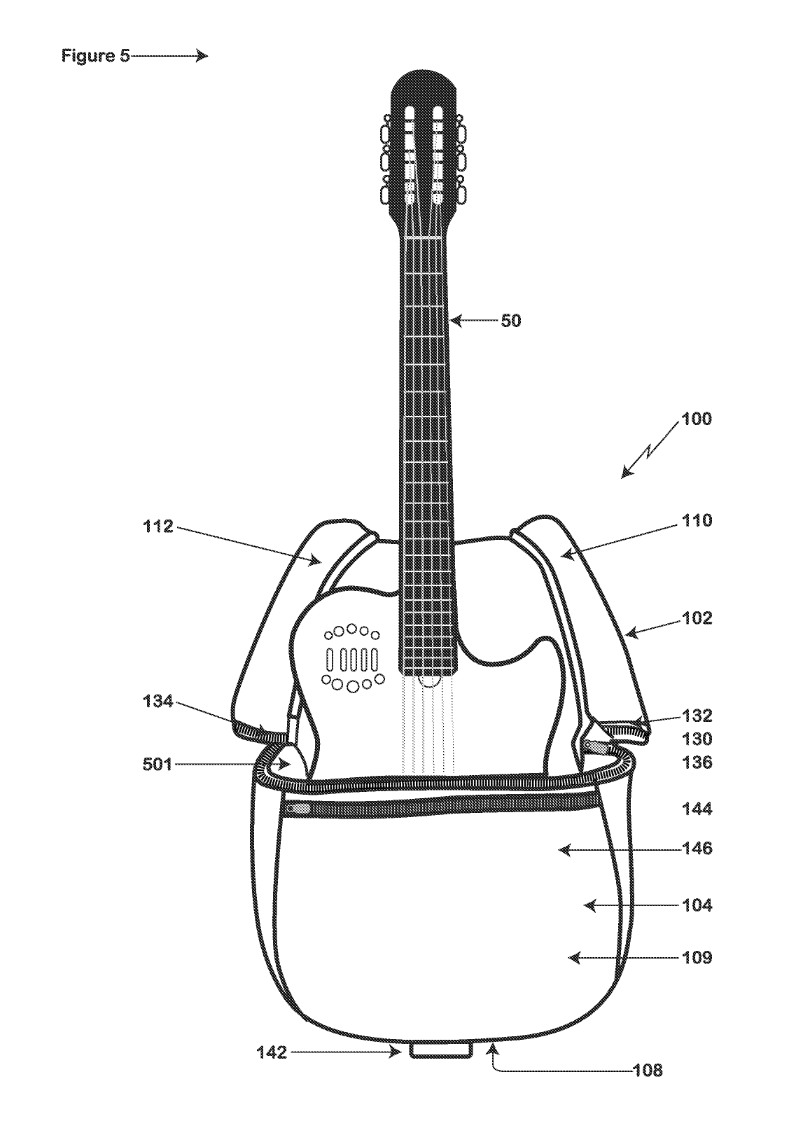

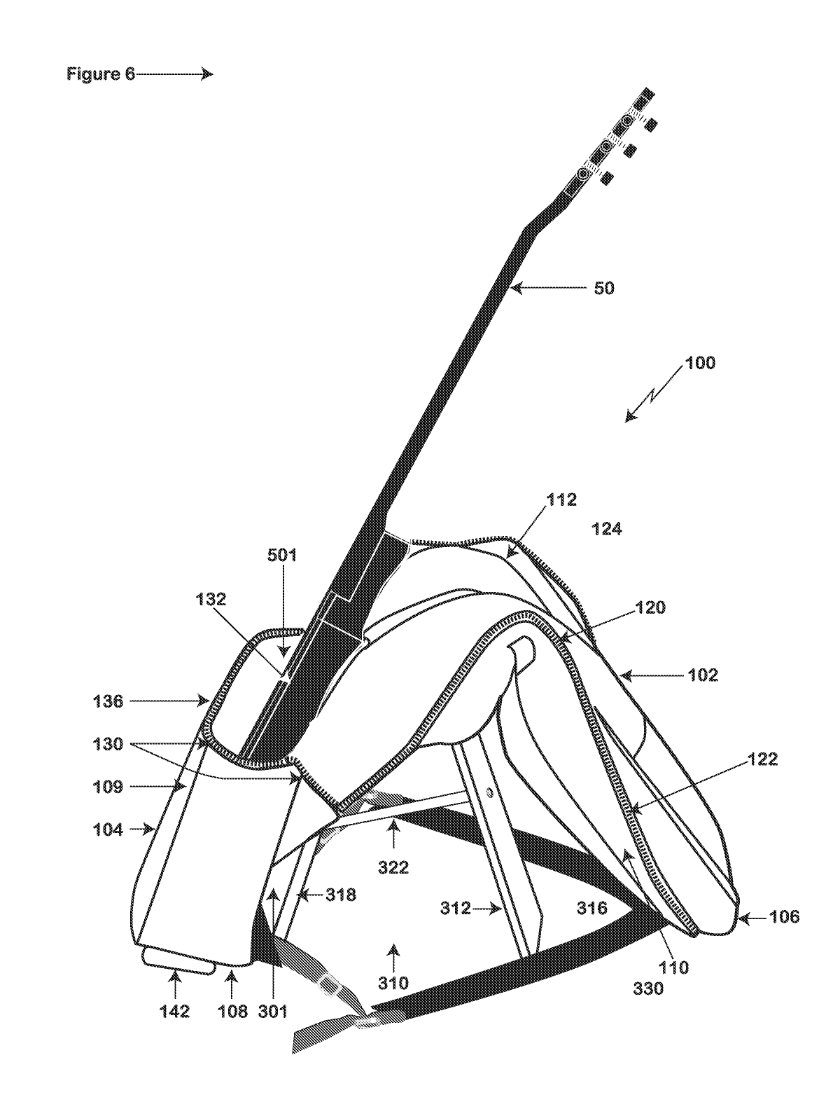

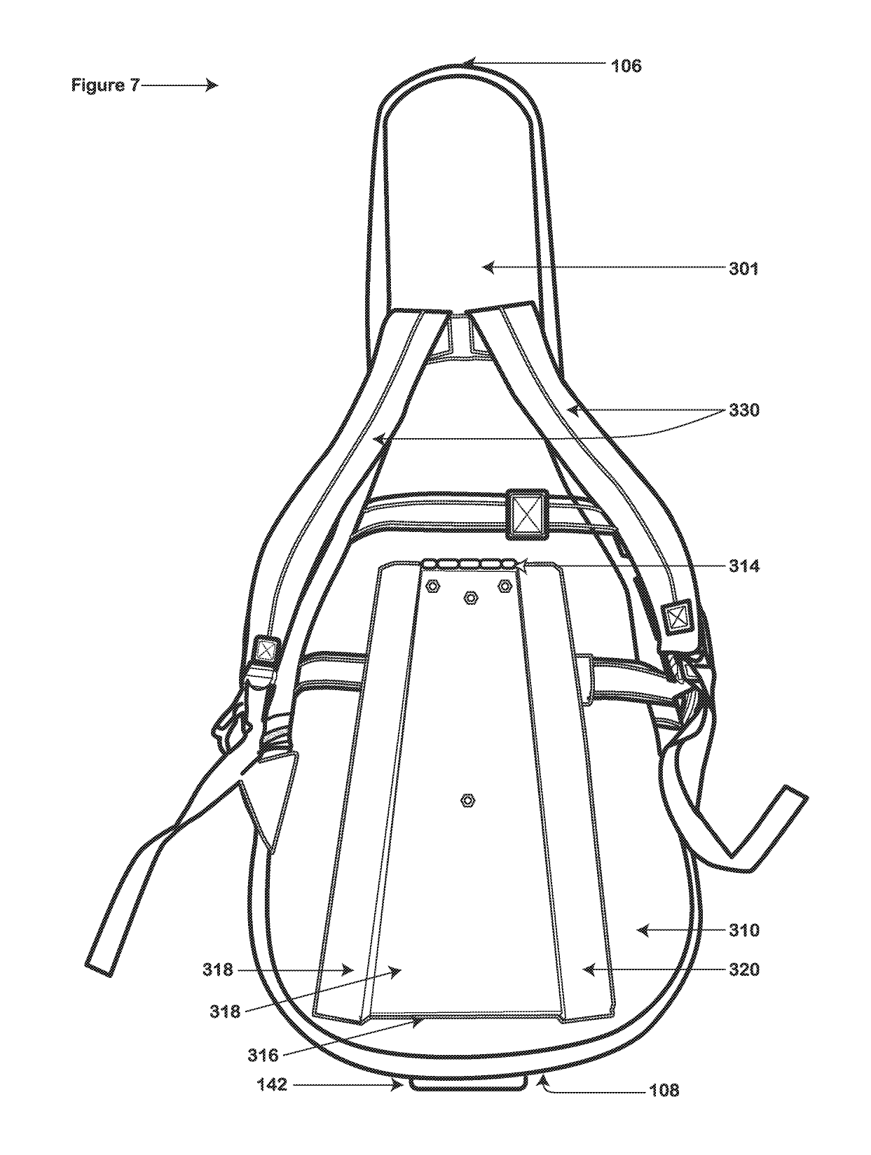

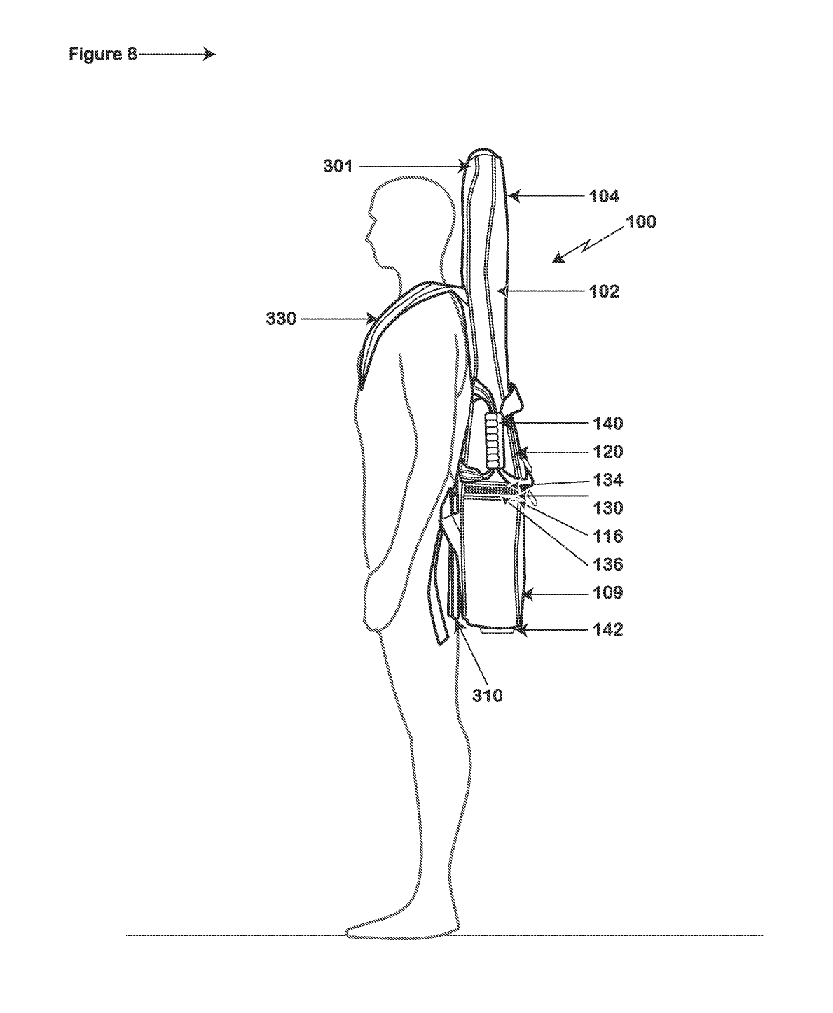

FIGS. 1-4A and 5-8 depict one exemplary musical instrument carrying case and stand 100 consistent with the present invention (also referenced as “carrying case and stand 100”). FIGS. 1 and 2 depict front views of the musical instrument carrying case and stand 100 in which the musical instrument (referenced as “50”) is enclosed within the case 102 and made accessible in accordance with the present invention as described herein. FIGS. 3 and 4A depict a rear view of the musical instrument carrying case and stand 100 showing the stand 310 in a case supporting position consistent with the present invention where the musical instrument 50 is enclosed within the case 102. FIGS. 5 and 6 depict a front and side view of the musical instrument carrying case and stand 100 showing a pocket 501 in the case 102 for holding the musical instrument 50, such as a guitar, upright in cooperation with the stand 310 in accordance with the present invention when the instrument 50 is not being used. FIG. 7 depicts a rear view of the musical instrument carrying case and stand 100 showing the stand 310 in a carrying position for a user to comfortably transport the carrying case and stand 100 as reflected in FIG. 8.

The carrying case and stand 100 has a case 102 that has a front side 104, a back side 301 (as shown in FIG. 3), a top side 106, and a bottom side 108. The sides 104, 301, 106, and 108 of the case 102 collectively define an internal cavity that accommodates a musical instrument 50. The bottom portion of the internal cavity is the pocket 501, shown in FIG. 5. The top portion of the internal cavity is the portion above the pocket 501, which may be accessed via front panel flaps 110 and 112 as further discussed herein.

The carrying case and stand 100 is illustrated for carrying and supporting guitars as the musical instrument 50. However, one of ordinary skill in the art, having reviewed the present application, will appreciate that the carrying case and stand 100 may be employed for carrying other musical instruments, e.g., banjos, violins, saxophones, cellos, or trombones.

The case 102 is made from a non-rigid material that may include leather, cloth, nylon, or other non-rigid materials or combinations thereof that lack support to keep the case 102 in an upright or standing position without a rigid skeletal structure or external frame. Thus, without the present invention, a non-rigid case would collapse to the floor when a musical instrument is removed from the case.

The front side 104 of the case 102 has a vertical slit 114 and horizontal slit 116 that collectively define a front panel 109 and a first flap 110. The vertical slit 114 and horizontal slit 116 are represented by zippers (i.e. fastening elements 120 and 130) in FIGS. 1 and 2. In FIG. 2, the zippers 120 and 130 are shown partially unzipped to reflect the vertical slit 114 and the horizontal slit 116 that provide access to the internal cavity of the carrying case and stand 100, so that the musical instrument 50 may be removed from or replaced therein while the stand 310 is in the supporting position as described herein. The horizontal slit 116 is disposed at a first predetermined distance (d1) from the bottom side 108 of the case 102 to define a pocket 501 (shown in FIG. 5) within the case 102 at a lower portion of the internal cavity. When the vertical slit 114 and the horizontal slit 116 are closed as shown in FIG. 1, the musical instrument 50 is enclosed and retained within the case 102. When the vertical slit 114 and the horizontal slit 116 are opened, as reflected in FIGS. 2 and 5, the musical instrument 50 can be removed from or replaced in the case 102.

In one implementation, the vertical slit 114 effectively intersects the horizontal slit 116 to define a first flap 110 and a second flap 112, as shown in FIG. 2. When the vertical slit 114 and the horizontal slit 116 are opened, the first flap 110 and the second flap 112 can be folded down to expose the musical instrument 50 within, as depicted in FIG. 5. The musical instrument 50 can then be easily removed from the pocket 501 within the case 102 for the user to play. Additionally, with the first flap 110 and the second flap 112 folded down, the user can also display the musical instrument 50 while it is in the non-rigid case 102 and supported by the stand 310 (as shown in FIG. 3) in accordance with the present invention. This is particularly useful when a user is performing and needs to swap instruments or to take a break between songs or before or after a show. Thus, without the present invention, a user desiring to remove a musical instrument from a case or display the musical instrument in the case would have to open the entirety of the case to do so, exposing the musical instrument to potential damage. Additionally, with the case 102 supported by the stand 310 (shown in FIG. 3), a user may more easily remove the musical instrument 50 from the case 102 without having to lay the case 102 on the ground to do so.

The vertical slit 114 and the horizontal slit 116 may have fastening elements 120 and 130 (shown in FIGS. 1-6 and 8 as zippers) to partially or completely close both slits 114 and 116. In this implementation, the first fastening element 120 may be comprised of a first part 122 attached to the first flap 110 on the front side 104 of the case 102, and a second part 124 attached to the second flap 112 on the front side 104 of the case 102, where the first and second parts 122 and 124 may be selectively engaged to close the vertical slit 114. When the first part 122 and the second part 124 are engaged or fastened, the musical instrument 50 is more securely retained within the case 102.

In the implementation shown in the figures, the first fastening element 120 is a zipper. In this implementation, the first part 122 and the second part 124 are the complementary teeth for the zipper. However, the first and second parts 122 and 124 of the first fastening element 120 may be formed from complementary hook and loop fasteners (or Velcro parts), buttons and corresponding button holes, complementary snap fasteners, or other fastening elements that can be engaged or disengaged by the user to allow access into the internal cavity of the case 102.

In the implementation shown in the figures, the second fastening element 130 is comprised of three parts 132, 134, and 136 that enable the two flaps 110 and 112 to be selectively engaged to the lower front panel 109. The second fastening element 130 is adapted to selectively close the horizontal slit 116. In this implementation, the third part 132 is attached to the first flap 110; the fourth part 134 is attached to the second flap 112; and the fifth part 136 is attached to the front panel 109. When the third part 132 and a portion of the fifth part 136 and the fourth part 134 and a remainder of the fifth part 136 are fastened to partially or completely close the horizontal slit 116, the musical instrument 50 is more securely retained within the case 102.

The second fastening element 130 may also be a zipper as shown in the figures. In this implementation, the third part 132, the fourth part 134, and the fifth part 136 are the complementary teeth for the zipper. However, the second fastening element 130 may be complementary hook and loop fasteners (or Velcro parts), buttons and corresponding button holes, complementary snap fasteners, or other fastening elements that can be engaged or disengaged by the user to allow access into the internal cavity of the case 102.

Additional features may also be added to the case 102. For example, a handle 140 may be attached to the case 102 to allow a user to carry the musical instrument carrying case and stand 100 by hand in a horizontal position. A foot stop 142 may also be attached to the bottom side 108 of the case 102 to further maintain the case 102 in an inclined or upright position or to prevent the case 102 from sliding on slick surfaces. The foot stop 142 may be made from rubber, wood, metal coated with rubber, or any other material that can assist the case 102 in resisting any sliding while in the inclined or upright position. The foot stop 142 may also be angled to cooperatively maintain the case 102 in a slightly angled, but upright, position with the stand 310. A front pocket 146 may also be included on the front panel 109 on the front side 104 of the case 102 for storing accessories for the musical instrument 50 or any other items, such as sheet music or guitar picks. This front pocket 146 may be secured by a fourth fastening element 144, such as a zipper as shown in FIGS. 1, 2, and 5, to selectively close the pocket 144. Carrying straps 330 (shown in FIG. 3) may be attached to the case 102 to allow users to transport the carrying case and stand 100 on their backs.

FIGS. 3 and 4A depict the rear view of the musical instrument carrying case and stand 100 consistent with the present invention. The stand 310 is attached to the back side 301 of the case 102. The stand 310 includes a support element 312 having a first end 314 and a second end 316 The first end 314 is pivotally attached to the back side 301 of the case 102. In FIGS. 3 and 4A, an exemplary pivotal attachment is shown as a hinge that is affixed to the non-rigid material of the carrying case 102, via adhesive, rivets, stitching, or other fastening means. The support element 312 may be made from metal, composites, plastics, wood, or any other rigid material capable of supporting the case 102 in an upright or inclined position with a musical instrument 50 inside.

When the carrying case and stand 100 is being transported, the support element 312 may be pivoted about the first end 314 to a first or carrying position where the support element 312 is substantially parallel with the back side 301 of the case 102. Alternatively, when the non-rigid carrying case 102 needs to be positioned in an upright or inclined position for access to the musical instrument 50 therein, the support element 312 can be pivoted to a second or supporting position. For this second position, the support element 312 of the stand 310 may be pivoted about the first end 314 so that the second end 316 of the support element 312 may be set at a second predetermined distance (d2) away from the case 102 (i.e. the “supporting position”), where the support element 312 supports the lower portion of the case 102, or pocket 501, and maintains the back of the lower part of the case 102 taut below the point where the first end 314 of the support element 312 is pivotally attached to the back side 301. When the lower part of the case 102 is taut, the pocket 501 (shown in FIG. 5) remains in an open position without the musical instrument 50 being disposed therein.

In one implementation, the second end 316 of the support element 312 is at least one inch wider than the first end 314, which adds stability to the carrying case and stand 100 when the stand 310 is deployed in the supporting position to keep the case 102 in an upright or inclined position. The second end 316 may have or incorporate a foot stop (e.g., a rubber end or stop) to further prevent the support element 312 from sliding.

A further implementation of the stand 310 may also include a first member 318 and a second member 320 attached to the back side 301 of the case 102. In this implementation, the support element 312 is disposed between first member 318 and second member 320, so that the first member 318 and the second member 320 can guide and horizontally retain the support element 312. These additional members 318 and 320 can provide extra rigidity to the back side 301 of the case 102 and can further stabilize the carrying case and stand 100 when used in an upright position. The first member 318 and the second member 320 may be made from materials such as metal, composites, plastics, wood, or other rigid materials. The support element 312, the first member 318, and the second member 320 may also each have a thickness such that each is co-planar with the others.

In another implementation, the stand 310 may have a strap 322 attached between the support element 312 and the back side 301 of the case 102. The strap 322 may be made from nylon, rope, cloth, rubber, or any other pliable material that can limit the distance the support element 312 can be pivoted to. Accordingly, the strap 322 may be used to limit the distance of the support element 312 to the predetermined distance (d2) away from the case 102 that will support the non-rigid case 102 with or without the musical instrument 50 inside. The strap 322 may be flattened and folded upon itself when the support element 312 is pivoted to the first or carrying position. In particular, when the support element 312 is pivoted to the first or carrying position, the strap 322 may be folded between the back side 301 of the case 102 and the support element 312.

In one embodiment, the support element 312 has a first thickness and each of the first and second members 318 and 320 have a second thickness that is greater than the first thickness. In this embodiment, when the support element 312 is pivoted to the first or carrying position, the strap 322 folds upon itself to have a third thickness such that the outer surface of the support element 312 is substantially co-planar (e.g. within 0 to ⅛ in.) of the outer surface of the first and second members 318 and 320. This co-planar embodiment enables the stand 310 to be comfortably pressed against a user's back when the carrying case and stand 100 is carried by the user as shown in FIG. 8.

A strap anchor 340 may also be attached to the back side 301 of the case 102 to which the strap 322 is attached instead of attaching the strap 322 directly to the back side 301 of the case 102. This can reduce the potential wear on the non-rigid case 102 when the support element 312 is pivoted many times and the strap 322 pulls on the non-rigid material of the case 102.

In a further implementation, the stand 310 may also have a third fastening element 324 attached to the back side 301 of the case 102 and the support element 312. This third fastening element 324 may be adapted to selectively attach the support element 312 to the back side 301 of the case 102. The third fastening element 324 retains the support element 312 against the back side 301 of the case 102 when the carrying case and stand 100 is being transported or stored. The third fastening element 324 may be a hook and loop fastener, snap fastener, or any other fastener that can be selectively engaged and disengaged.

FIGS. 5 and 6 depict the carrying case and stand 100 with the vertical slit 114 and the horizontal slit 116 opened and the first flap 110 and the second flap 112 folded down to expose the musical instrument 50 within the non-rigid case 102, consistent with the present invention. With the flaps 110 and 112 folded down, the user can easily remove the musical instrument 50 from the pocket 501 of the case 102. When the musical instrument 50 is removed, the pocket 501 does not collapse with the stand 310 in the supporting position, as described herein. This allows the user to put the musical instrument 50 back into the pocket 501 of the non-rigid case 102 without lying the non-rigid case 102 down or manually holding the non-rigid case 102 upright. Thus, without the present invention, a non-rigid case would collapse the pocket and the musical instrument could not be easily replaced into the case.

FIG. 4B depicts the stand 401 of a second embodiment of a carrying case and stand 400 consistent with the present invention. The case 102 and other components included on the front side 104 of the case 102 may be the same or consistent with those described for the carrying case and stand 100 of the first embodiment. In the embodiment shown in FIG. 4B, a first member 402 and a second member 404 are attached to the back side 301 of the case 102. The first member 402 and the second member 404 may be made from materials such as metal, composites, plastics, wood, or other rigid materials. A support element 406, having a first end 408 and a second end 410, is pivotally attached between the first member 402 and the second member 406 at the first end 408. The support element 406 may also be made from materials such as metal, composites, plastics, wood, or other rigid materials. In this embodiment, the support element 406 is pivotally attached by a rod 413 that spans through the first end 408 of the support element 406 and between the first member 402 and the second member 404.

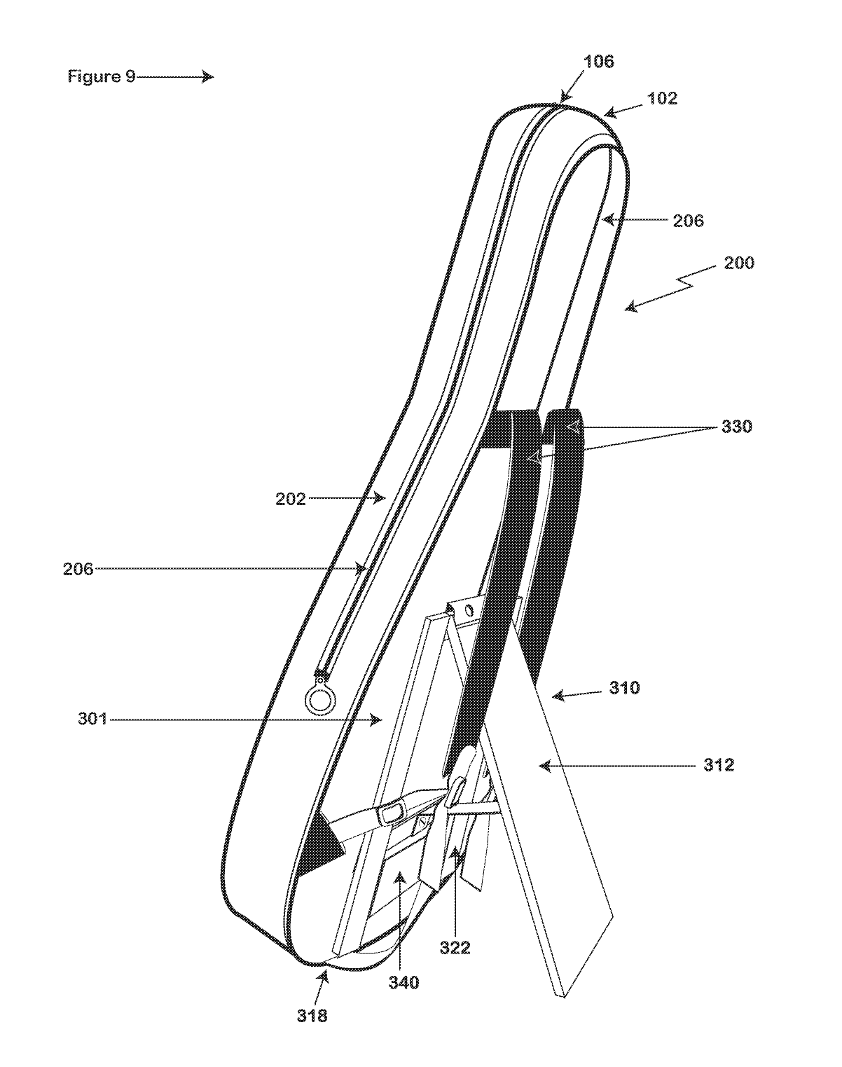

FIGS. 9-12 relate to an example of a musical instrument carrying case and stand 200 (also referred to as “carrying case and stand 200” for short), in accordance with another embodiment of the present invention. Note that various components, such as the case 102 and the stand 310 for instance, may be the same or similar to those described in connection with other embodiments disclosed herein. Hence, some of the same reference numerals designating various components shown in FIGS. 1-8 are also shown in FIGS. 9-12.

Like other embodiments described above, according to the present embodiment, the case 102 has a slit that is positioned to define at least one flap and a pocket within the case 102 corresponding to a lower portion of an internal cavity of the case 102. FIG. 9 depicts a side view of one example of the carrying case and stand 200 in accordance with the present embodiment.

In the embodiment of FIGS. 9-12, only one slit is used to define at least one flap. As shown in FIG. 9, the carrying case and stand 200 includes the case 102 that has the front side 104 (not explicitly shown in FIG. 9), the back side 301, the top side 106, and the bottom side 108.

Similar to the embodiment depicted, e.g., in FIGS. 1-2, the sides 104, 301, 106, and 108 of the case 102 collectively define an internal cavity that accommodates the musical instrument 50. As described in connection with other embodiments, the case 102 is made from a non-rigid material, some examples of which include leather, cloth, and nylon and combinations thereof Such non-rigid material lacks support to keep the case 102 in an upright or standing position without a rigid skeletal structure or external frame. The case 102 also includes a side portion 202 and a side portion 204 (not explicitly shown in FIG. 9) that adjoin the front side 104 and the back side 301, and that extend between the top side 106 and the bottom side 108. As such, the top side 106 and the bottom side 108 are disposed between the side portions 202 and 204. Note that the side portions 202 and 204 and the top and bottom sides 106 and 108 may be all formed from a common piece of the non-rigid material or may be formed from separate pieces. In another example configuration, portions of the non-rigid material that form the front side 104 and the back side 301 of the case 102 may be joined together in such way as to provide respective side portions and top and bottom sides for an internal cavity having a shape suitable to accommodate a given musical instrument, such as a string instrument having a main body portion and an elongated neck portion (e.g., a guitar). Other examples are possible as well.

As further shown in FIG. 9, the carrying case and stand 200 also includes the stand 310, including the support element 312, as described in connection with FIGS. 3 and 4A. Note, however, that in an alternative implementation, the carrying case and stand 200 can instead include the stand 401, including the support element 406, as described in connection with FIG. 4B. In general, the stand 310 may include various components described herein, such as the strap 322 and additional support members, such as the first member 318 and the second member 320 (not explicitly shown in FIG. 9). As in other implementations described above, the strap anchor 340 may also be attached to the back side 301 of the case 102. Further, the carrying case and stand 200 may also include the carrying straps 330 attached to the case 102 to allow users to transport the carrying case and stand 200 on their backs. Additional features not illustrated in FIG. 9 may also be included, such as the handle 140, allowing a user to carry the case 102 by hand.

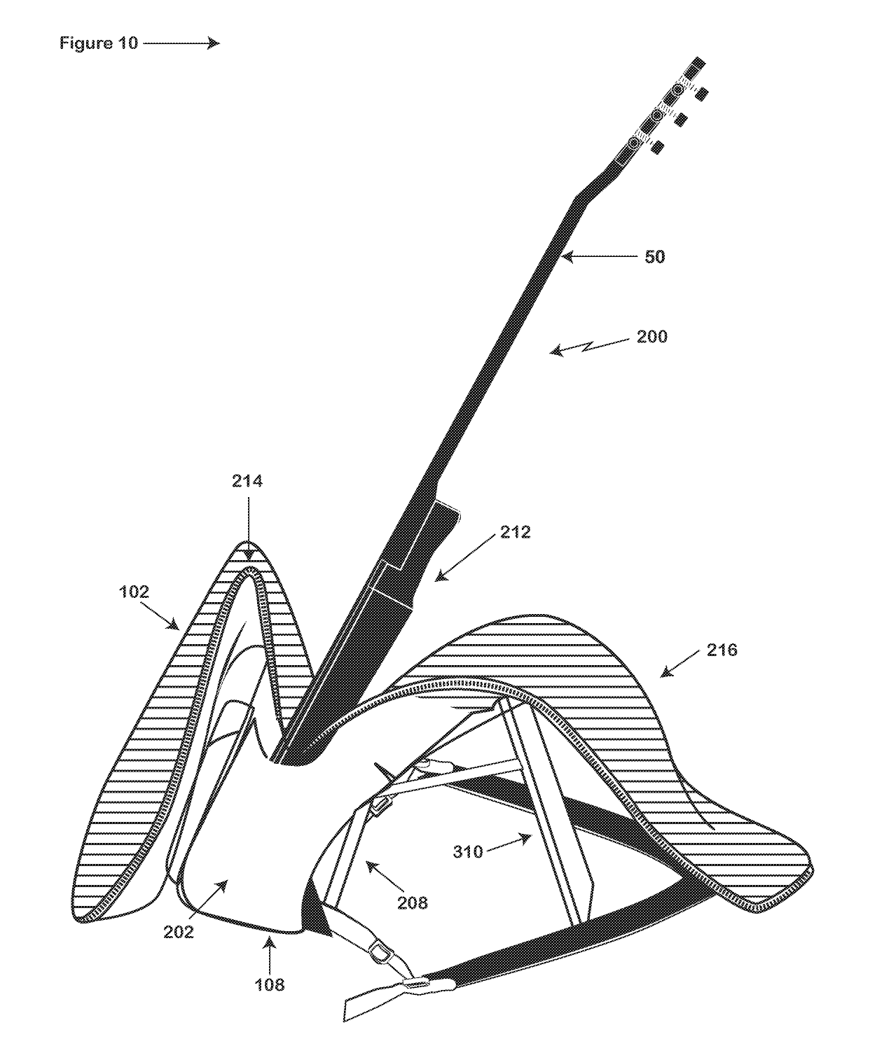

In one example implementation shown in FIG. 9, a single slit, namely a slit 206, is provided on the side portions 202 and 204 and the top side 106. In FIG. 9, the slit 206 is represented by a zipper, which is one example of a fastening element suitable to selectively close the slit 206. The slit 206 extends relatively vertically down the side portion 202, relatively vertically down the side portion 204, and across the top side 106. When the slit 206 is open (such when the fastening element is unfastened), as shown in FIG. 10, the slit 206 allows access to the internal cavity of the case 102. Further, in accordance with the present embodiment, the musical instrument 50 can be removed from or replaced in the case 102 while the stand 310 is in the supporting position as described above. When the slit 206 is closed, as shown in FIG. 9, the musical instrument 50 can be enclosed and retained within the case 102.

Note that the zipper shown in FIG. 9 could be similar to the zipper 120 described above, having the first part 122 and the second part 124 that are complementary teeth for the zipper. However, the fastening element could also include two zippers instead of one. Further, the fastening element could take other forms as well, such as complementary hook and loop fasteners, buttons and corresponding button holes, complementary snap fasteners, or other suitable fastening elements that can be engaged or disengaged by a user to allow access to the internal cavity of the case 102.

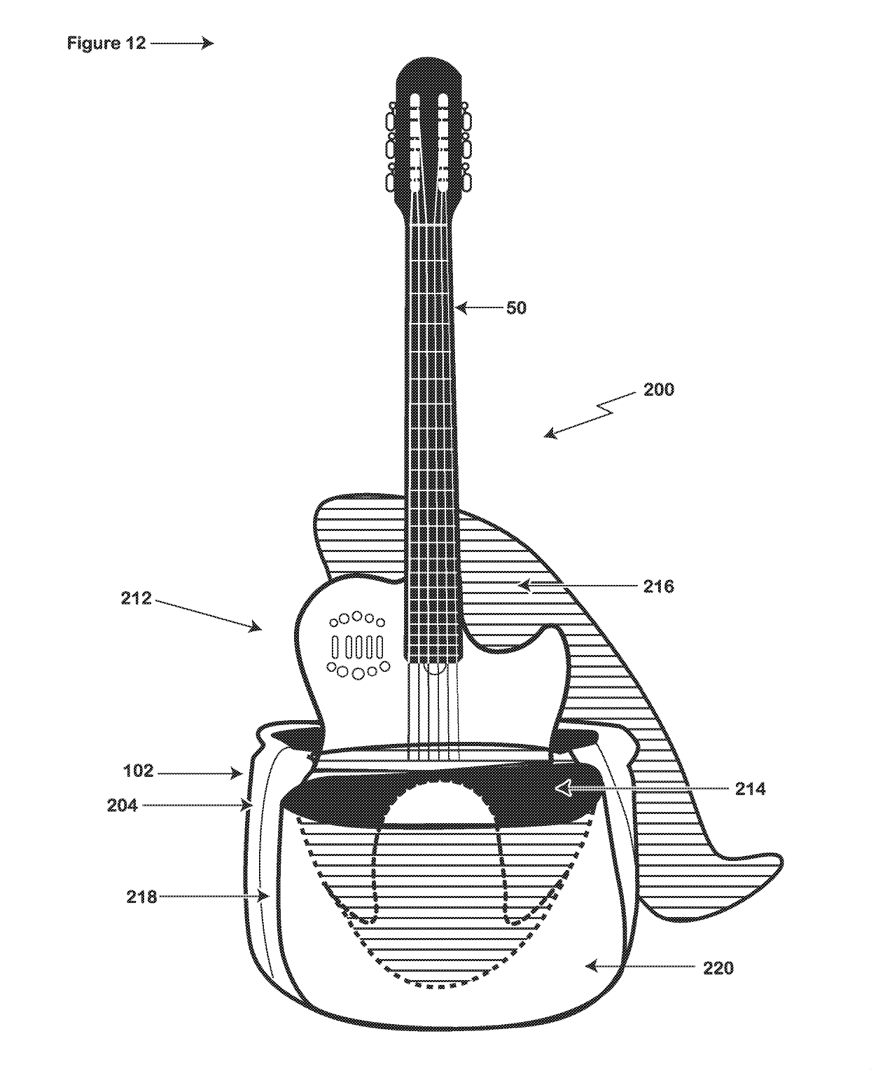

As shown in FIG. 10, the slit 206 extends down to a first position 208 on the side portion 202. Similarly, although not explicitly shown in FIG. 10, the slit 206 extends down to a second position 210 on the side portion 204. The first position 208 and the second position 210 are each provided at a respective predetermined distance away from the bottom side 108 of the case 102 (or, generally, from some reference position on the bottom of the case 102) such that a pocket 212 (also shown in FIG. 12) can be formed within the case 102 when the slit 206 is open between the first position 208 and the second position 210. The pocket 212 may be similar to the pocket 501 described herein in connection with other embodiments.

Preferably, the respective predetermined distance is substantially same for both positions 208 and 210, but variations are possible. Further, the first position 208 and the second position 210 are selected to be such that, when the slit 206 is open between these positions, the musical instrument 50 can be securely held in the pocket 212 and easily removed therefrom by a user while the case 102 is being supported by the stand 310. In this regard, the first and second positions 208 and 210 may be set accordingly to provide a desired depth of the pocket 212. Note, however, that the slit 206 can be only partially open by the user, as needed, such as to gain access to or expose only some portion of the musical instrument 50 above the pocket 212 predefined by the positions 208 and 210.

As depicted in FIG. 10, the slit 206 is positioned such that a front flap 214 and a back flap 216 are defined on the front side 104 and the back side 301 of the case 102, respectively. More specifically, when the slit 206 is open (such as between the first and second positions 208 and 210), the front flap 214 and the back flap 216, both made from the non-rigid material of the case 102, can be folded down to expose the musical instrument 50 inside the case 102. As such, a user can easily remove the musical instrument 50 from the pocket 212 within the case 102. Further, with the support provided by the stand 310, the user does not have to lay the case 102 down in order to be able to remove the musical instrument 50 from the case 102. In addition, with the front flap 214 and the back flap 216 folded down, the user can also display/temporarily store the musical instrument 50 while it is in the case 102 and supported by the stand 310. Such feature is useful, for example, when the user is performing and needs to swap instruments during a performance, or when the user wishes to take a break during, before, or after a show.

In FIG. 10, the case and stand 200 has two flaps (front and back) when the slit 206 is open, but in another implementation (not shown), the slit 206 could be positioned such that only a front-side flap would be formed to expose at least a part of a front portion of the musical instrument 50 (e.g., the part not enclosed within the pocket 212). In particular, in this implementation, aside from the front-side flap, remaining portions of the case 102 could substantially stay covering other parts of the musical instrument 50 (unless specifically pulled down off the instrument and folded by a user) when the slit 206 is open and the case 102 is supported by the stand 310. This way, for instance, the user could still gain access to the internal cavity of the case 102 (such as to pull some article from the pocket 212), without unnecessarily exposing the rest of the musical instrument 50. This could help to protect the musical instrument 50 from a possible damage, while allowing access to the internal cavity of the case 102 in an upright position.

In such implementation, the slit 206 could, for instance, extend along an outer periphery of the front side 104 of the case 102 (e.g., extend along and in a vicinity of a border (e.g., a seam)) between the front side 104 and the two side portions 202 and 204, and the top side 106) between two side positions similar to the positions 208 and 210. The slit 206 could be, for example, disposed on the front side 104 itself or, alternately, on the two side portions 202 and 204 and the top side 106 as described above. Further, the slit 206 would be preferably positioned such that the top side 106 of the case 102 would substantially stay put over at least a part of the top of the musical instrument 50 (e.g., over the top of a neck of a guitar or some other string instrument) when the slit 206 is open and the case 102 is supported by the stand 310. As such, only the front-side flap could be folded down by a user. Of course, the user could then pull the rest of the case 102 off the musical instrument 50 if so desired or needed to take the instrument out of the case 102.

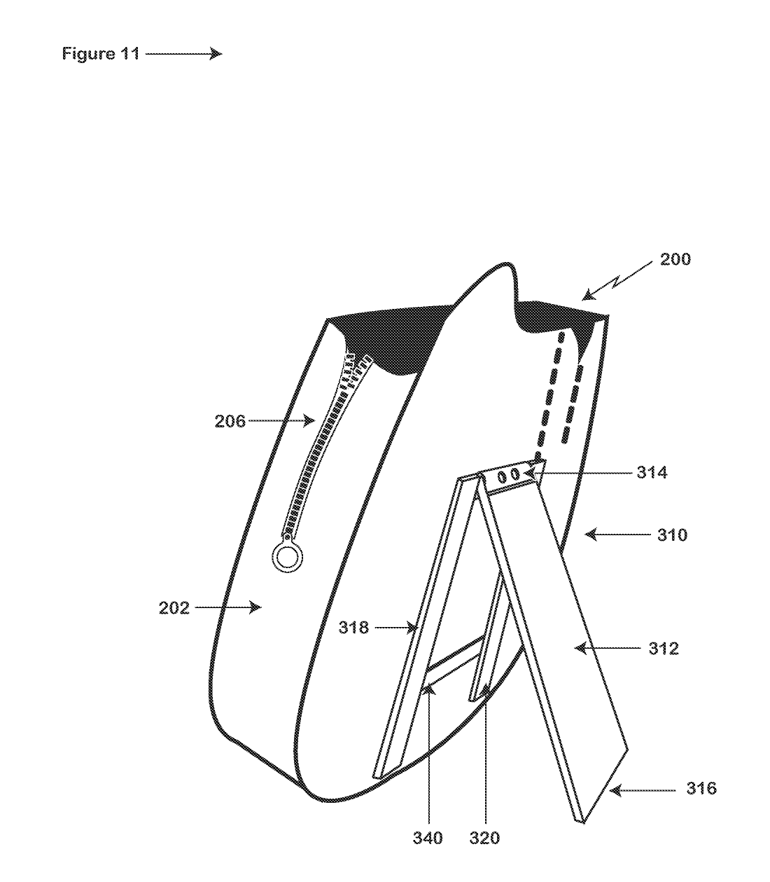

FIG. 11 is a rear view of the carrying case and stand 200 in accordance with the present embodiment, including the stand 310 and some of its constituent components described above in connection with FIGS. 3 and 4A. As described above, the stand 310 includes the support element 312 having the first end 314 and the second end 316. The first end 314 is pivotally attached to the back side 301 of the case 102, such by a hinge or other pivotal attachment that may be affixed to the non-rigid material of the case 102 via various fastening means (e.g., adhesive, rivets, stitching, or other fastening means). Further, the support element 312 may be made from any rigid material capable of supporting the case 102 in an upright or inclined position with the musical instrument 50 being disposed inside.

Further, as described in detail above, the support element 312 may be pivoted about the first end 314 to the first or carrying position where the support element 312 is substantially parallel with the back side 301 of the case 102, such when the carrying case and stand 200 is being transported. On the other hand, when the non-rigid case 102 needs to be positioned in an upright or inclined position for access to the musical instrument 50 disposed in the case 102, the support element 312 may be pivoted to the second or supporting position (as shown in FIG. 11).

Similar to the embodiment described hereinabove in connection with FIG. 3, in the supporting position, the second end 316 of the support element 312 may be set at a predetermined distance away from the case 102 (or more particularly, from the bottom of the case 102), where the support element 312 supports the lower portion of the case 102, or pocket 212, and maintains the back of the lower part of the case 102 taut below the point where the first end 314 of the support element 312 is pivotally attached to the back side 301. As in the case of the pocket 501, when the lower part of the case 102 is taut, the pocket 212 remains in an open position without the musical instrument 50 being disposed therein.

As further shown in FIG. 11, the support element may also include the first member 318 and the second member 320 attached to the back side 301 of the case 102, where the support element 312 is disposed between the first member 318 and second member 320. This way, the first member 318 and the second member 320 can guide and horizontally retain the support element 312. As described above, the first and second members 318 and 320 can provide extra rigidity to the back side 301 of the case 102 and can also stabilize the carrying case and stand 200 when used in an upright position. The first member 318 and the second member 320 may be made from various rigid materials (e.g., metal, composites, plastics, wood, etc.). Further, the support element 312, the first member 318, and the second member 320 may also each have a thickness such that each is co-planar with the others.

Note that other details and various implementations of the stand 310 described hereinabove (e.g., an addition of the strap 322 attached between the support element 312 and the back side 301 of the case 102, as shown in FIG. 9) could be also used in connection with the carrying case and stand 200 of the present embodiment, and hence detailed description thereof is omitted. Also, as noted above, in an alternative example, the carrying case and stand 200 could also be constructed with the stand 401 (and its various constituent components) as shown in FIG. 4B and discussed above.

FIG. 12 is a front view of the carrying case and stand 200 of the present embodiment, including the pocket 212 holding the musical instrument 50 when the case 102 is an upright position (as supported by the stand in the back (not shown)). More particularly, FIG. 12 shows one implementation in which, when the front flap 214 is folded down along a horizontal fold line between the first position 208 and the second position 210 (not explicitly shown in FIG. 12), a front panel 218 is created. Such front panel 218 may be similar to the front panel 109 defined below the horizontal slit 116 in other embodiments. Further, a front pocket 220 may be included on the front panel 218. The size of the front pocket 220 may be such that the front flap 214 can be folded and conveniently tucked into this pocket, as shown in FIG. 12. This way, for instance, a user can keep the front flap 214 out of the way while it is folded down to expose the musical instrument 50. Note that, similarly, a back panel can be created when the back flap 216 is folded down along a horizontal fold line between the first position 208 and the second position 210, and another back pocket can be disposed on such back panel. Such back pocket could be similarly used to tuck the back flap 216 when it is folded down.

Note that, although not shown in FIG. 12, the front pocket 220 can be fastened by a suitable fastening element (e.g., a zipper, as in the pocket 146 described earlier) that could be unfastened to open the front pocket 220 in order to tuck the front flap 214 thereinto. Alternatively, the user could use such front pocket for storing accessories for the musical instrument 50 or any other items (e.g., sheet music, guitar picks, etc.). However, alternatively or in addition to, another pocket can be included in a different location on the case 102 (e.g., on the back side 301 and/or the side portion(s)) for such storage purposes. Such pocket can be, e.g., secured by a suitable fastening element, such as a zipper, to selectively close the pocket.

In summary, in one example in accordance with the present embodiment, the carrying case and stand 200 may have the slit 206 positioned to define the front flap 214 and the back flap 216. When the slit 206 is open, the front flap 214 and the back flap 216 can be folded down to expose the musical instrument 50 within the case 102 made of the non-rigid material as described above. With the front and back flaps 214 and 216 folded down, a user can easily remove the musical instrument 50 from the pocket 212 of the case 102. Further, with the stand 310 (or, more specifically, the support element 312) being in the supporting position, when the musical instrument 50 is removed, the lower portion of the internal cavity of the case 102 is supported, and the pocket 212 does not collapse but rather remains in a open position. As such, the user can put the musical instrument 50 back into the pocket 212 of the case 102, without having to lie down the case 102 or having to manually support the case 102 in an upright manner.

Advantageously, with the benefits of the present invention, a user can use the carrying case and stand in accordance with various embodiments described herein to store their musical instrument inside when transporting the musical instrument from one performance to the next. Once the user arrives at the destination, the user can then pivot the support element to the second position to keep the non-rigid case in an upright or inclined position with the lower portion of the non-rigid case taut between the pivot point of the first end of the support element so that the pocket in the lower portion of the non-rigid case is maintained in an open position. The stand integrated with the case, as described herein, reduces a number of items a music player needs to transport when traveling with their musical instrument. Additionally, the non-rigid case material reduces the weight and cost as compared to other rigid instrument cases with stands. When the user desires to either display their instrument or play their instrument, one or more slits, as described herein, can be opened, and the flap(s) defined by such slit(s) can then be folded down to expose or display the musical instrument. The user can then remove the musical instrument from the pocket and the pocket will not collapse. When the user is done playing, the musical instrument can be returned to the pocket to effectively maintain the musical instrument in an upright position while the musical instrument is not in use. When the user is ready to transport the musical instrument to a new location, the user can fold up the flap(s), close the slit(s), pivot the support element to the first position, and carry the case holding the musical instrument using means such as the handle or the carrying straps described herein.

Further, in one implementation, padding (such as foam or stiff fabric) may be disposed in the bottom, internal corners of the pocket within the case to provide further support for the musical instrument when the carrying case and stand is positioned in a reclined or upright position as described herein. In addition, the case may include other structural materials such as boning elements in the fabric used to form the case.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A musical instrument carrying case and stand, comprising:
a case having an internal cavity configured to hold a musical instrument, the case comprising a non-rigid material;
one or more slits in the case allowing access to the internal cavity, the one or more slits positioned to define at least one flap; and
a support element having a first end and a second end, the first end being pivotally attached to a back side of the case, the support element pivoting between a first position in which the support element is substantially parallel with the back side of the case and a second position in which the second end of the support element is set away from the case, and when in the second position, the support element being able to support the case without the musical instrument being disposed therein.

2. A musical instrument carrying case and stand, comprising:
a case having a front side, a back side, a top side, and a bottom side that collectively define an internal cavity configured to accommodate a musical instrument, the front side and the back side being adjoined by a first side portion and a second side portion that extend between the top side and the bottom side, the case being formed from a non-rigid material;
a slit that extends (a) relatively vertically down the first side portion of the case to a first position, (b) relatively vertically down the second side portion of the case to a second position, and (c) across the top side of the case, the top side being between the first and second side portions, the slit defining at least one flap, and the first position and the second position each being provided at a respective predetermined distance from the bottom of the case so as to define a pocket within the case corresponding to a lower portion of the internal cavity; and
a support element having a first end and a second end, the first end being pivotally attached to the back side, the support element pivoting between one position in which the support element is substantially parallel with the back side of the case and another position in which the second end of the support element is at least a second predetermined distance away from the bottom of the case such that the support element supports the lower portion of the internal cavity of the case when the instrument is removed from the pocket.
